(19) United States
(12) Patent Application Publication
(10) Pub. No.: US 2026/0246040 A1
(43) Pub. Date: Aug. 20, 2026

(54) METHOD FOR MANUFACTURING LEAD TAB FOR SECONDARY BATTERY AND DEVICE FOR MANUFACTURING LEAD TAB FOR SECONDARY BATTERY

(71) Applicant: NSM CO., LTD., Cheongju-si (KR)

(72) Inventor: Se Yong LEE, Cheongju-si (KR)

(21) Appl. No.: 19/182,081

(22) Filed: Apr. 17, 2025

(30) Foreign Application Priority Data
Feb. 18, 2025 (KR) 10-2025-0020639

(51) Int. Cl. H01M 50/186; B32B 15/085; H01M 50/533; H01M 50/534

(52) U.S. Cl. CPC H01M 50/186; B32B 15/085; H01M 50/533; H01M 50/534; B32B 2250/02; B32B 2457/10

(57) ABSTRACT

A method for manufacturing a lead tab for a secondary battery of an embodiment may include (a) temporarily joining a sealant film to upper and lower surfaces of a metal plate; (b) transferring the metal plate to which the sealant film is temporarily joined into a chamber; (c) providing a vacuum pressure inside the chamber; and (d) pressurizing and adhering the sealant film to a surface of the metal plate inside the chamber. According to the embodiment, a vacuum pressure providing and heating/pressurizing process may be applied so as to significantly reduce a number of processes for removing bubbles formed on a mutual bonding surface between a metal plate and a sealant film compared to the prior art, thereby improving productivity due to the reduction in processes as well as maximizing bubble removal efficiency so as to improve yield.

### CROSS REFERENCE TO RELATED APPLICATION

The present application claims priority to Korean Patent Application No. 10-2025-0020639, filed February 18, 2025, the entire contents of which are incorporated here for all purposes by this reference.

### BACKGROUND OF THE INVENTION

### Field of the Invention

The present disclosure relates to a method for manufacturing a lead tab for a secondary battery and a device for manufacturing a lead tab for a secondary battery.

### Background of the Related Art

In general, secondary batteries are batteries that can be used repeatedly through a discharge process that converts chemical energy into electrical energy and a charging process that converts electrical energy into chemical energy. Secondary batteries may include nickel-cadmium (Ni-Cd) batteries, nickel-metal hydride (Ni-MH) batteries, lithium-metal batteries, lithium-ion (Li-Ion) batteries, and lithium-ion (Li-Ion) polymer batteries.

The lithium secondary batteries may include an electrode assembly accommodated in a battery case, a metal plate electrically connected to electrode tabs of electrodes provided in the electrode assembly and extending outside the battery case, and a sealant film (insulating film) that electrically insulates the metal plate.

In particular, the sealant film may perform a function of sealing an interface between a metal plate and an electrode case by having one side fused to the metal plate and the other side opposite to the one side fused to the electrode case.

Here, a secondary battery lead tab must form a high-quality fusion interface between the metal plate and the sealant film due to its structural feature of penetrating an inside/outside of a pouch-type electrode case that accommodates positive and negative electrode plates and an electrolyte.

For example, when bubbles are generated at the fusion interface between the metal plate and the sealant film, they expand as the temperature rises during the use of the secondary battery, causing leakage or explosion, so thorough preparations must be made to prevent the creation of bubbles.

To this end, conventionally, prior to adhering a metal plate and a sealant film to each other, a process of heating and pressurizing each of them multiple times to join them to each other has been carried out, but, even through such adhesion by heating and pressurizing multiple times, there has occurred a problem in that bubbles are generated at a fusion interface between the metal plate and the sealant film.

### CITATION LIST

### Patent Literature

(Patent Document 0001) Korean Patent Publication No. 10-2023-0032144 (published on March 7, 2023)

### SUMMARY OF THE INVENTION

The present disclosure has been made to solve the foregoing conventional problems, and an aspect of the present disclosure is to provide a method for manufacturing a lead tab for a secondary battery and a device for manufacturing a lead tab for a secondary battery, which can significantly reduce a number of processes for removing bubbles present at a fusion interface between a metal plate and a sealant film compared to the prior art so as to improve productivity due to the reduced number of processes, and completely suppress the generation of bubbles, thereby greatly improving product yield.

According to one aspect of the present disclosure, there is provided a method for manufacturing a lead tab for a secondary battery including (a) temporarily joining a sealant film to upper and lower surfaces of a metal plate; (b) transferring the metal plate to which the sealant film is temporarily joined into a chamber; (c) providing a vacuum pressure inside the chamber; and (d) pressurizing and adhering the sealant film to a surface of the metal plate inside the chamber.

The step (c) may be implemented to remove bubbles present between the metal plate and the sealant film.

The step (d) may be carried out while maintaining a set vacuum pressure formed inside the chamber through the step (c).

The step (d) may be carried out while heating the sealant film to a first temperature above a predetermined level.

The step (d) may be carried out while heating the metal plate around the sealant film to a second temperature above a predetermined level, wherein in the step (d), the heating of the sealant film and the heating of the metal plate are performed simultaneously, and the sealant film is adhered to the metal plate while melting a contact portion with the metal plate.

The first temperature and the second temperature may be the same.

The step (d) may be carried out while a heating block that generates high temperature heat for heating the sealant film and the metal plate does not come into direct contact with the sealant film and the metal plate, but comes into indirect contact with them through a buffer member having a higher ductility than the sealant film and the metal plate.

According to another aspect of the present disclosure, a device for manufacturing a lead tab for a secondary battery, which adheres a sealant film to a metal plate, the device may include a chamber having an internal space above a predetermined size and an opening formed on one side; a transfer unit that can grip the metal plate to which the sealant film is temporarily joined and then transfer it into the chamber or transfer it from an inside of the chamber to the outside; a vacuum unit that provides a vacuum pressure inside the chamber; a pressurizing unit configured to allow at least a portion of the sealant film to be accessible to the metal plate so as to pressurize the sealant film against a surface of the metal plate or to be movable to be spaced apart in an opposite direction; and a control unit that controls the operations of the transfer unit, the vacuum unit, and the pressurizing unit.

The transfer unit may include a gripping part that can grip or ungrip the metal plate to which the sealant film is temporarily joined; and a transfer part that moves the gripping part toward the chamber or conversely, transfers it away therefrom, wherein the gripping portion is configured to open or close the opening of the chamber and also has a structure that can seal an internal space of the chamber to the outside.

The control unit may drive the vacuum unit to maintain an inside of the chamber at a set vacuum pressure, and drive the pressurizing unit to pressurize and adhere the sealant film to a surface of the metal plate.

The pressurizing unit may pressurize the sealant film and the metal plate around the sealant film while heating them to a temperature above a predetermined level.

A portion of the pressurizing unit that comes into contact with the sealant film may be configured to have a cross-sectional area larger than that of the sealant film.

The pressurizing unit may be provided on each of the upper and lower sides of the metal plate, each of which includes a heating block configured to generate a high temperature above a predetermined temperature; and a pressurizing movement part that can move the heating block toward or conversely, away from the metal plate and the sealant film, and when moving toward, the heating block pressurizes the sealant film so as to be closely adhered to the metal plate.

The pressurizing unit may further include a buffer member provided on one side of the heating block to have an elastic restoring force so as to allow the heating block to be configured to come into direct contact with the metal plate and the sealant film while preventing the heating block from coming into direct contact with the metal plate and the sealant film.

According to a method for manufacturing a lead tab for a secondary battery and a device for manufacturing a lead tab for a secondary battery in the present disclosure described above, a vacuum pressure providing and heating/pressurizing process may be applied so as to significantly reduce a number of processes for removing bubbles formed on a mutual bonding surface between a metal plate and a sealant film compared to the prior art, thereby improving productivity due to the reduction in processes as well as maximizing bubble removal efficiency so as to improve yield.

To elaborate, unlike in the past, the heating and pressurizing process may be implemented only once, and even when the heating and pressurizing process is implemented only once under vacuum pressure, the metal plate and the sealant film may be mutually adhered with a sufficient adhesive force while sufficiently suppressing the creation of bubbles.

In addition, by maintaining an inside of a chamber in a vacuum state while an actual adhesion (full joining) of the sealant film is performed through a pressurizing unit, bubbles remaining in a mutual bonding portion between the metal plate and the sealant film may be more reliably prevented, thereby maximizing an increase in yield.

In addition, since the pressurizing unit is configured to heat the metal plate surrounding the sealant film together with the sealant film, the sealant film may be easily melted and adhered to the metal plate by receiving the high temperature of the metal plate.

In addition, by providing a buffer member over an entire surface of a heating block facing the metal plate, a scratch, a tear or the like may occur on the metal plate and the sealant film while the heating block pressurizes the metal plate and sealant film so as to minimize a decrease in yield.

### BRIEF DESCRIPTION OF THE DRAWINGS

FIGS. 1 to 6 are drawings sequentially showing a process of manufacturing a secondary battery lead tab using a device for manufacturing a lead tab for a secondary battery according to an embodiment of the present disclosure,

FIG. 7 is a diagram showing a state in which sealant films are adhered at left and right edges in a width direction of a metal plate during a process of manufacturing a secondary battery lead tab using a device for manufacturing a lead tab for a secondary battery according to an embodiment of the present disclosure, wherein (a) is a diagram showing a configuration in which a void space is formed at an interface with the metal plate as a state in which the sealant films are temporarily joined, and (b) is a diagram showing a configuration in which a void space from which air (bubbles) have been removed by a vacuum is filled while the sealant films are melted by receiving high temperature so as to perform mutual adhesion between the sealant films as a state in which the sealant films are fully joined,

FIG. 8 is a flowchart showing a method for manufacturing a lead tab for a secondary battery according to an embodiment of the present disclosure.

### DETAILED DESCRIPTION OF THE PREFERRED EMBODIMENT

Hereinafter, an embodiment of the present disclosure will be described in more detail with reference to the accompanying drawings. However, the present disclosure is not limited to the embodiment disclosed below but may be implemented in various different forms, and the present embodiments are merely provided to make a full disclosure of the present disclosure and to allow those skilled in the art to know the full range of the disclosure. In the drawings, the same reference numerals refer to the same elements.

A method for manufacturing a lead tab for a secondary battery according to a preferred embodiment of the present disclosure may significantly reduce a number of processes for removing bubbles formed on a mutual bonding surface between a metal plate and a sealant film, thereby improving productivity due to the reduction in processes as well as maximizing bubble removal efficiency so as to improve yield.

That is, the present disclosure provides a lead tab that completely removes bubbles to improve a mutual bonding strength between a metal plate and a sealant film so as to maintain a state in which the sealant film is stably adhered to the metal plate. Here, the sealant film is interposed between the metal plate and a secondary battery cell pouch so as to be used not only as a seal to prevent leakage of an electrolyte, but also for electrical insulation.

Hereinafter, the present disclosure will be described with reference to an embodiment.

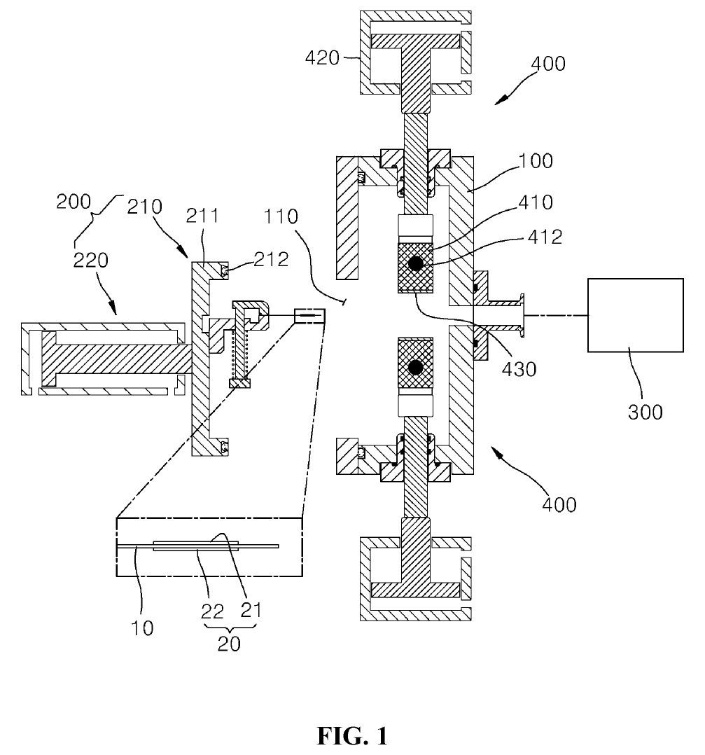

As shown in FIGS. 1 to 6, a device for manufacturing a lead tab for a secondary battery according to an embodiment of the present disclosure may adhere a sealant film 20 to a metal plate 10, which includes a chamber 100, a transfer unit 200, a vacuum unit 300, a pressurizing unit 400, and a control unit (not shown).

The chamber 100 has an internal space above a predetermined size and an opening 110 is formed on one side thereof. The chamber 100 has an internal space sufficient to allow a portion of the transfer unit 200 and a portion of the pressurizing unit 400, which will be described later, to be arranged therein.

The transfer unit 200 is configured to grip the metal plate 10 to which the sealant film 20 is temporarily joined and then transfer it into the chamber 100 or to transfer the metal plate 10 that has been transferred into the chamber 100 back to the outside.

The temporary joining between the sealant film 20 and the metal plate 10 is performed in a separate process. More specifically, the metal plate 10 made of aluminum, copper (nickel), or the like is preheated to a temperature of approximately 100 to 250 degrees Celsius (all temperatures in this specification refer to Celsius temperatures), and a temporary joining process is performed while loading the sealant film 20 onto upper and lower surfaces of the preheated metal plate 10. The temporary joining process is performed by pressurizing the sealant film 20 against the preheated metal plate 10 for 1 to 15 seconds, wherein the sealant film 20 made of a thin plastic material (PP, etc.) comes into contact with the high-temperature metal plate 10, and the contact portion melts instantaneously so as to have a state of being temporarily joined to the metal plate 10.

The transfer unit 200 may be configured to reciprocate between a work region where such temporary joining is performed and the chamber 100.

As shown in FIGS. 1 to 6, the transfer unit 200 includes a gripping part 210 and a transfer part 220.

The gripping part 210 is configured to have a structure that can grip or ungrip the metal plate 10 to which the sealant film 20 is temporarily joined. The related drawing discloses a structure in which a pair of grippers constituting the gripping part 210 elastically pressurize upper and lower sides of the metal plate 10 by an elastic force of an elastic spring so as to grip and, when necessary, ungrip the metal plate 10.

The transfer part 220 is used to move the gripping part 210 toward the chamber 100 or conversely, transfer it away therefrom, and may be applied to various types of units, such as a cylinder unit, a ball screw unit, or an LM transfer guide unit, which reciprocate the gripping part 210 in a straight line. The related drawing shows, as an example, a case where the transfer part 220 is applied as a cylinder unit.

In an embodiment of the present disclosure, the gripping part 210 is configured to open or close the opening 110 of the chamber 100, and also has a structure that can seal an internal space of the chamber 100 to the outside.

Specifically, as shown in FIG. 1, the gripping part 210 includes a gripping block 211 having a cross section that is bent approximately in the shape of the letter "C" so as to close the opening 110 while coming into contact with a wall surrounding the opening 110 of the chamber 100.

As described below, a sealing member 212 is provided at a contact end portion of the gripping block 211 that can come into contact with a wall surrounding the opening 110 of the chamber 100 to prevent vacuum pressure leakage when an inside of the chamber 100 is evacuated.

The sealing member 212 is made of a flexible material such as rubber or silicone, and the inside of the chamber 100 is preferably evacuated as described below in a state that the sealing member 212 is also deformed in shape such that the transfer part 220 transfers the gripping part 210 toward the chamber 100 so as to allowing the gripping block 211 to pressurize the chamber 100 at a pressure above a predetermined level.

Next, the vacuum unit 300, which provides a vacuum pressure inside the chamber 100, may be applied as a vacuum pump, or the like, and may be connected to the chamber 100 through a separate pipe.

Next, as shown in FIGS. 1 to 6, the pressurizing unit 400 is configured such that at least a portion thereof is accessible to the metal plate 10 or configured such that it is movable in an opposite direction to pressurize the sealant film 20 to a surface of the metal plate 10. To elaborate, the pressurizing unit 400, which performs a full joining process rather than a temporary joining process, pressurizes the sealant film 20 to more reliably adhere the currently temporarily joined sealant film 20 to the metal plate 10.

The pressurizing unit 400 performs a fusion process while removing bubbles (air) between the metal plate 10 and the sealant film 20 by vacuum.

The pressurizing process (full joining) by the pressurizing unit 400 may be implemented at least once within the chamber 100 as described below, and the metal plate 10 and the sealant film 20 for which the pressurizing process (full joining) by the pressurizing unit 400 has been completed may be withdrawn outside the chamber 100 and an additional pressurizing process may be implemented to increase an adhesive force between the metal plate 10 and the sealant film 20 under atmospheric pressure conditions.

As described above, since the metal plate 10 is already heated to about 100 to 250 degrees for temporarily joining the sealant film 20, even when a temperature drop occurs during the transfer process into the chamber 100, the temperature of the metal plate 10 located inside the chamber 100 may be maintained at a considerable temperature. Therefore, the pressurizing unit 400 may only apply a 'pressurizing operation' to completely adhere the sealant film 20 to a surface of the metal plate 10.

However, the present disclosure may adopt a structure in which a 'heating operation' is additionally performed while the pressurizing unit 400 pressurizes the sealant film 20 so as to allow 'pressurizing' and 'heating' to be applied simultaneously, and in this case, the sealant film 20 may be adhered more efficiently and reliably than when only 'pressurizing' is applied.

That is, the pressurizing unit 400 may heat the sealant film 20 and the metal plate 10 around the sealant film 20 to a temperature above a predetermined level while simultaneously pressurizing to adhere the sealant film 20 to the metal plate 10.

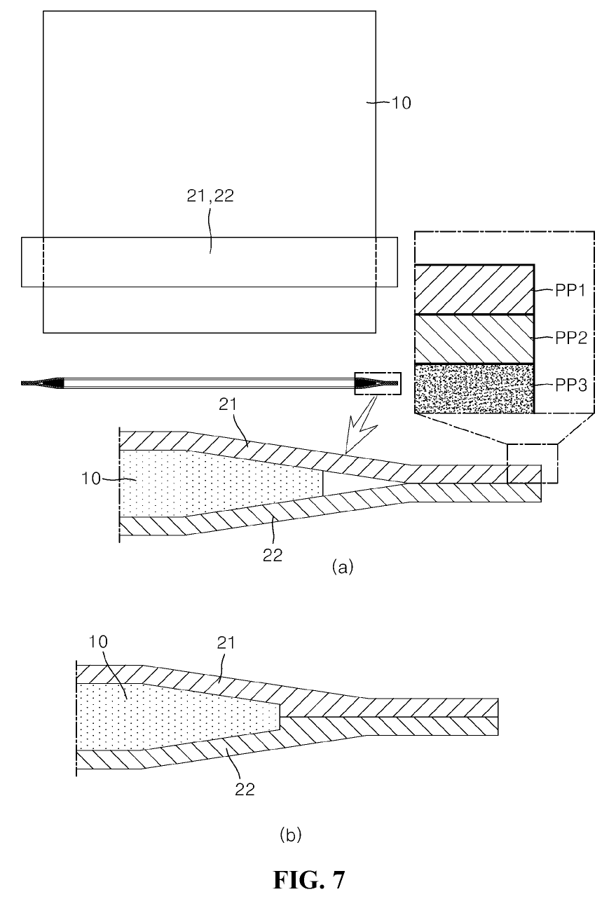

In addition, as shown in FIG. 7, the sealant film 20 has a triple film layer structure made of a PP material, and a lowermost layer in the drawing has a characteristic that allows it to be more easily adhered to the metal plate 10, and a uppermost layer has a characteristic that allows it to be more easily adhered to a secondary battery pouch.

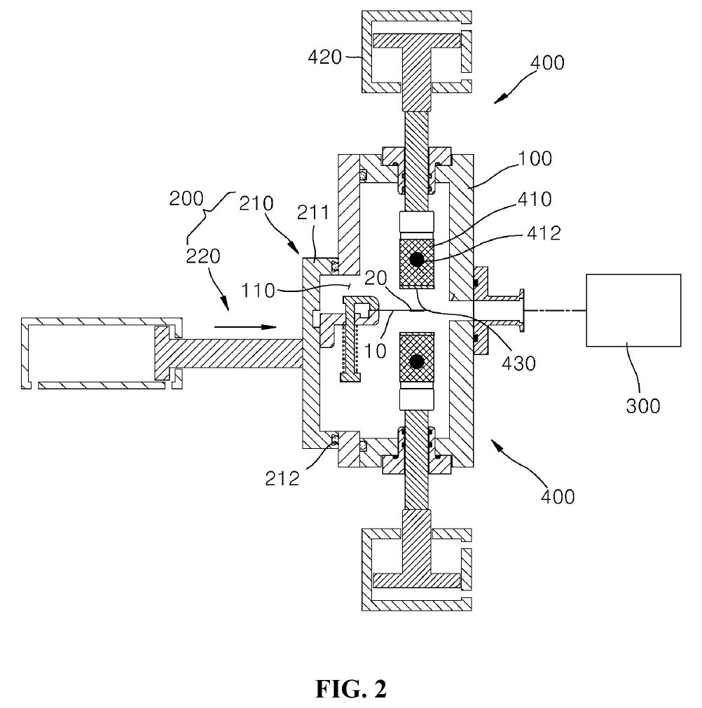

As shown in FIGS. 2 to 5, in an embodiment of the present disclosure, a portion of the pressurizing unit 400 that comes into contact with the sealant film 20 is configured to have a cross-sectional area larger than that of the sealant film 20. Accordingly, when the pressurizing unit 400 is moved toward the metal plate 10 to come into contact therewith, not only the sealant film 20 but also the metal plate 10 around the sealant film 20 may be heated to a temperature above a predetermined level.

In this way, when the metal plate 10 around the sealant film 20 is also heated, the lowermost PP layer of the sealant film 20 may be easily melted and adhered to the metal plate 10 by receiving the high temperature of the heated metal plate 10. That is, fusion is performed between the sealant film 20 and the metal plate 10.

As will be described again below, as shown in (a) of FIG. 7, edges on both sides in a width direction of the metal plate 10 are formed in a tapered shape, and due to such a tapered shape, a region may occur where a first sealant film 21 and a second sealant film 22 that are temporarily joined do not adhere to each other.

In this way, the area where the first sealant film 21 and the second sealant film 22 are not adhered to each other may disappear subsequent to a full joining process in which the pressurizing unit 400 simultaneously pressurizes the first sealant film 21 and the second sealant film 22 from upper and lower sides of the metal plate 10, as shown in (b) of FIG. 7, wherein, as described above, the void region is filled while a lowermost PP layer of each of the first sealant film 21 and the second sealant film 22 is melted by receiving high temperature so as to perform mutual adhesion between the first sealant film 21 and the second sealant film 22.

As shown in FIGS. 1 to 6, the pressurizing units 400 are provided on upper and lower sides of the metal plate 10, respectively, which include a heating block 410 and a pressurizing movement part 420, respectively.

The heating block 410 is installed so as to be always located within the chamber 100, and configured to generate a high temperature above a predetermined temperature. For example, the heating block 410 is made of a metal material and has a heater 412 installed on the inside to generate a high temperature. The heater 412 may form a high temperature of approximately 100 to 250 degrees, and the high temperature is transmitted to the metal plate 10 and the sealant film 20. That is, the heating block 410 is heated to about 100 to 250 degrees prior to coming into contact with the metal plate 10 and the sealant film 20, and when the heated heating block 410 comes into pressurized contact with the metal plate 10 and the sealant film 20, heat is transmitted to the metal plate 10 and the sealant film 20. Here, the heating temperature of the heating block 410 may vary depending on the type and characteristics of the sealant film 20.

At least part of the pressurizing movement part 420 is installed inside the chamber 100 and the remaining part thereof is installed outside the chamber 100 so as to move the heating block 410 toward or conversely, away from the metal plate 10 and the sealant film 20.

The pressurizing movement part 420 may be applied to various types of units, such as a cylinder unit, a ball screw unit, and an LM transfer guide unit, which can move the heating block 410 in a straight reciprocating manner. The related drawing shows, as an example, a case where the pressurizing movement part 420 is applied as a cylinder unit.

The pressurizing movement part 420 moves the heating block 410, and the heating block 410 pressurizes the sealant film 20 so as to be closely adhered to the metal plate 10. In addition, as described above, the pressurizing movement part 420 is arranged on an outside of the metal plate 10 to perform a function of fusing edge areas of the first sealant film 21 and the second sealant film 22 that are not adhered to the metal plate 10.

Meanwhile, the heating block 410 includes a metal material, and when the heating block 410 comes into direct contact with the metal plate 10 and the sealant film 20 and pressurizes them, a scratch, a tear or the like may occur on the metal plate 10 and the sealant film 20, which may be a factor in reducing yield.

To supplement this, in an embodiment of the present disclosure, as shown in FIGS. 1 to 6, the pressurizing unit 400 further includes a buffer member 430.

In the present disclosure, when the heating block 410 approaches the metal plate 10 by driving the pressurizing movement part 420, the heating block 410 does not come into direct contact with the metal plate 10 and the sealant film 20. In contrast, when the heating block 410 approaches the metal plate 10 by driving the pressurizing movement part 420, the buffer member 430 is configured to come into direct contact with the metal plate 10 and the sealant film 20.

Here, the buffer member 430 is preferably provided over an entire surface of the heating block 410 facing the metal plate 10, and is made of a material having an elastic restoring force. For example, the buffer member 430 may be applied as a silicone sponge.

To elaborate, when the pressurizing unit 400 is driven, only the buffer member 430 comes into direct contact with the metal plate 10 and the sealant film 20, and the heating block 410 does not comes into direct contact but indirect contact therewith, but high temperature heat formed in the heating block 410 may be sufficiently transmitted to the metal plate 10 and the sealant film 20 through the buffer member 430.

The buffer member 430 is configured to transmit heat together with the metal plate 10 and the sealant film 20, and to be elastically deformable, and thus may be used to overcome a thickness difference between the metal plate 10 and the sealant film 20 and to evenly transmit heat and pressure over the entire surface.

In an embodiment of the present disclosure, the control unit (not shown) controls the operations of the transfer unit 200, the vacuum unit 300, and the pressurizing unit 400, which drives the vacuum unit 300 to maintain an inside of the chamber 100 at a set vacuum pressure, and drives the pressurizing unit 400 to pressurize and adhere the sealant film 20 to a surface of the metal plate 10.

That is, by maintaining an inside of the chamber 100 in a vacuum state while an actual adhesion (full joining) of the sealant film 20 is performed through the pressurizing unit 400, bubbles remaining in a mutual bonding portion between the metal plate 10 and the sealant film 20 may be more reliably prevented, thereby maximizing an increase in yield.

To elaborate, when an atmospheric pressure is formed inside the chamber 100 while an adhesion of the sealant film 20 is performed, bubbles between the thin sealant film 20 and the metal plate 10 may not be properly pushed outward (discharged) so as to remain between the sealant film 20 and the metal plate 10. However, in the present disclosure, as described above, an inside of the chamber 100 may be continuously maintained in a vacuum state while an actual adhesion of the sealant film 20 is performed through the pressurizing unit 400, thereby fundamentally preventing the creation of bubbles at a mutual bonding portion between the metal plate 10 and the sealant film 20 at the moment when the thin sealant film 20 is pressurized and adhered.

Hereinafter, a method for manufacturing a lead tab for a secondary battery according to an embodiment of the present disclosure will be described.

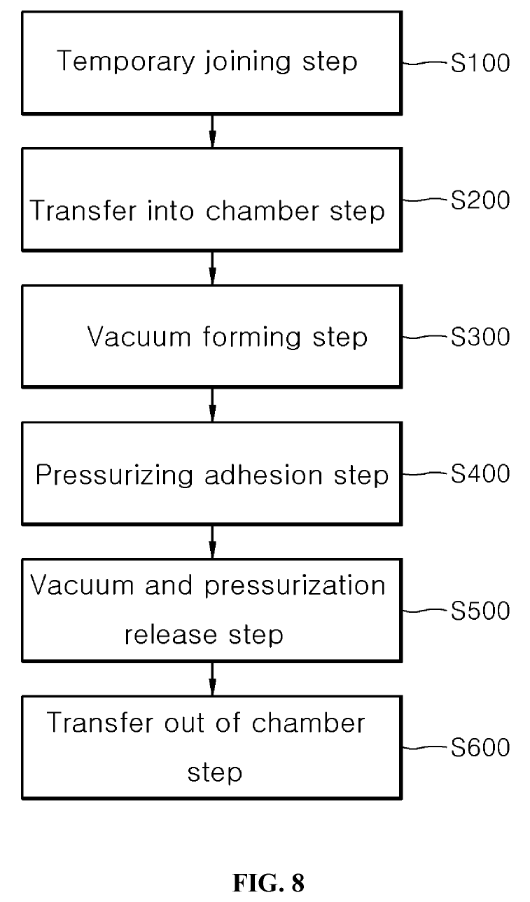

As shown in FIG. 8, a method for manufacturing a lead tab for a secondary battery according to an embodiment of the present disclosure includes a temporary joining step (S100), a transfer into the chamber 100 step (S200), a vacuum forming step (S300), a pressurizing adhesion step (S400), a vacuum and pressurization release step (S500), and a transfer out of the chamber 100 step (S600).

First, the metal plate 10 made of aluminum, or the like, is preheated to a temperature of approximately 100 to 250 degrees, and the sealant film 20 is loaded onto upper and lower surfaces of the preheated metal plate 10 and pressurized them for 1 to 15 seconds, thereby performing a process of temporarily joining the sealant film 20 to the metal plate 10 (S100).

Furthermore, as shown in FIGS. 1 and 8, the metal plate 10 to which the sealant film 20 is temporarily joined is prepared in advance so as to allow the gripping part 210 to be in a gripped state.

Next, as shown in FIGS. 2 and 8, the metal plate 10 to which the sealant film 20 is temporarily joined is transferred into the chamber 100 (S200).

Specifically, the transfer part 220 moves the gripping part 210 toward the chamber 100 so as to allow the metal plate 10 to be located at an inside of the chamber 100. At this time, the opening 110 of the chamber 100 is closed by the gripping part 210, and an inside of the chamber 100 is sealed to the outside.

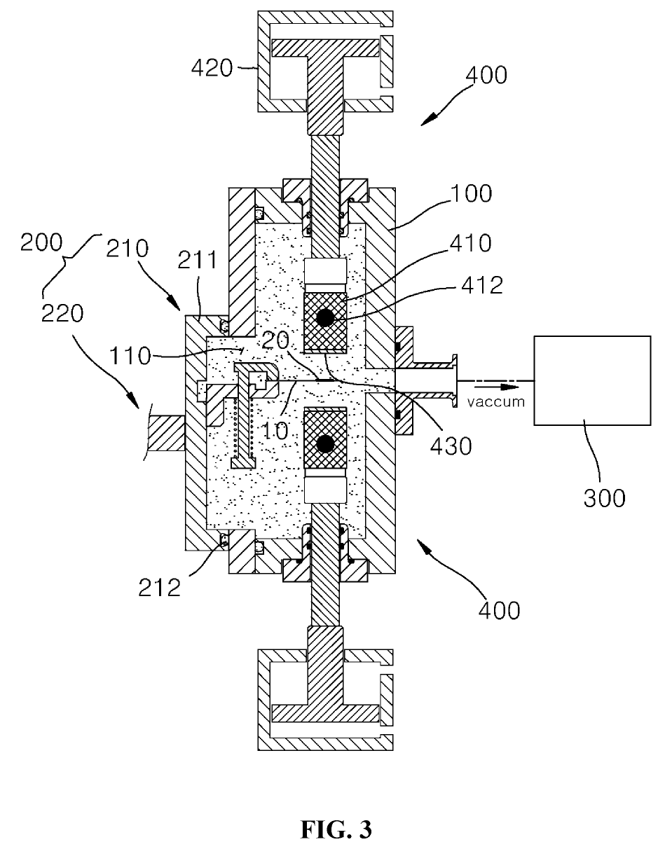

Next, as shown in FIGS. 3 and 8, a vacuum pressure is provided inside the chamber 100 (S300). Step S300 is implemented to remove bubbles present between the metal plate 10 and the sealant film 20, wherein the vacuum unit 300, such as a vacuum pump, is driven so as to allow a set vacuum pressure to be formed inside the chamber 100.

If bubbles are present at a bonding portion between the metal plate 10 and the sealant film 20, the bubbles are removed from the bonding portion between the metal plate 10 and the sealant film 20 while being transferred to a connecting portion of the vacuum unit 300 connected to the chamber 100 so as to provide a vacuum pressure.

In addition, while the vacuum pressure is maintained, bubbles, or the like located at the bonding portion between the metal plate 10 and the sealant film 20 maintain a state of being continuously removed by the vacuum pressure.

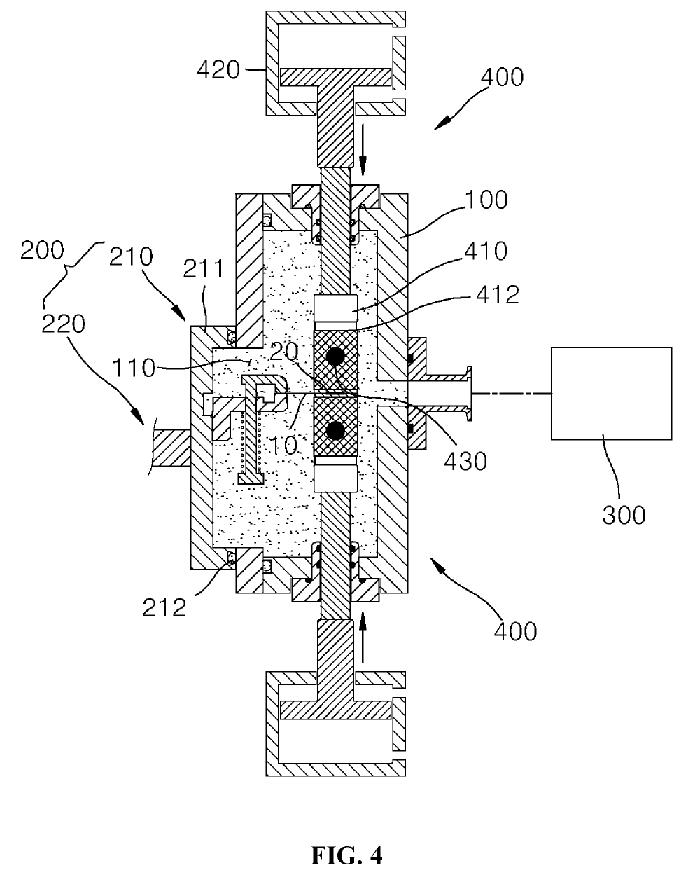

Next, as shown in FIG. 4 and FIG. 8, the sealant film 20 is pressurized and adhered to a surface of the metal plate 10 within the chamber 100 (S400).

The present disclosure may implement only a 'pressurizing operation' to adhere the sealant film 20 thereto, but for more efficient adhesion, it adopts a structure in which a 'heating operation' is additionally performed while the pressurizing unit 400 pressurizes the sealant film 20 so as to allow 'pressurization' and 'heating' to be applied simultaneously.

That is, the pressurizing unit 400 may heat the sealant film 20 and the metal plate 10 around the sealant film 20 to a temperature above a predetermined level while simultaneously pressurizing to adhere the sealant film 20 to the metal plate 10.

In an embodiment of the present disclosure, step S400 is carried out while heating the sealant film 20 to a first temperature above a predetermined temperature, and carried out while heating the metal plate 10 around the sealant film 20 to a second temperature above a predetermined temperature.

Here, the first temperature and the second temperature may be applicable in the same manner and may be applied at, for example, 100 to 250 degrees.

In an embodiment of the present disclosure, in step S400, heating of the sealant film 20 and heating of the metal plate 10 are performed simultaneously. To elaborate, while the heating block 410 indirectly pressurizes the metal plate 10 and the sealant film 20 through the buffer member 430, high temperature heat formed in the heating block 410 is simultaneously transmitted to the sealant film 20 and the metal plate 10. Here, the heating block 410 may be heated to about 100 to 250 degrees, and a time for which the buffer member 430 pressurizes the metal plate 10 and the sealant film 20 may be 1 to 15 seconds.

Accordingly, the sealant film 20 may be adhered to the metal plate 10 while melting a contact portion with the metal plate 10.

In an embodiment of the present disclosure, step S400 is carried out in a state where the heating block 410 that generates high temperature heat for heating the sealant film 20 and the metal plate 10 does not come into direct contact with the sealant film 20 and the metal plate 10, but comes into indirect contact therewith through the buffer member 430 having a higher ductility than the sealant film 20 and the metal plate 10.

Additionally, in an embodiment of the present disclosure, step S400 is carried out while maintaining a set vacuum pressure formed inside the chamber 100 through step S300.

That is, by maintaining an inside of the chamber 100 in a vacuum state while an actual adhesion of the sealant film 20 is performed through the pressurizing unit 400, bubbles remaining in a mutual bonding portion between the metal plate 10 and the sealant film 20 may be more reliably prevented, thereby maximizing an increase in yield.

Here, unlike in the past, step S400 may be implemented only once, and even when implemented once, the metal plate 10 and the sealant film 20 may be mutually adhered with a sufficient adhesive force while suppressing the creation of bubbles. That is, a heating/pressurizing process for adhering the sealant film 20 may be implemented only once in a vacuum state rather than having to be implemented multiple times more than twice, so productivity may be greatly increased by omitting a number of processes compared to the prior art.

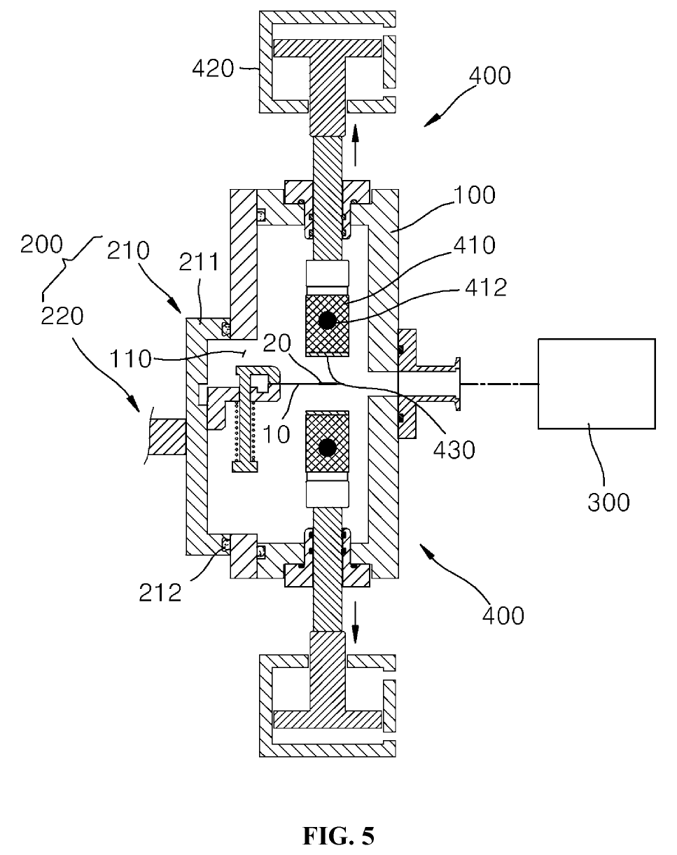

Next, as shown in FIG. 5 and FIG. 8, the vacuum unit 300 is driven off to release a vacuum state within the chamber 100, and the pressurizing movement part 420 is driven to allow the heating block 410 to be spaced apart from the metal plate 10 (S500).

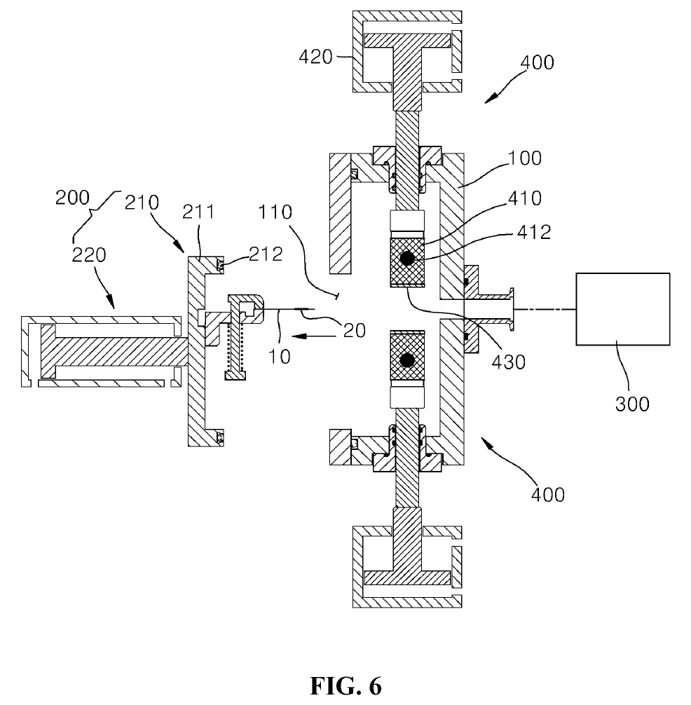

Next, as shown in FIGS. 6 and 8, the metal plate 10 on which the sealant film 20 is fully joined is pulled out of the chamber 100 (S600).

Specifically, the transfer part 220 moves the gripping part 210 to an outside of the chamber 100 to pull the metal plate 10 on which the sealant film 20 is fully joined out of the chamber 100. At this time, the opening 110 of the chamber 100 is opened again by the movement of the gripping part 210. In this way, the metal plate 10 pulled out of the chamber 100 is transferred to a post-process.

In the above, although the present disclosure has been shown and described with reference to preferred embodiments for illustrating the principles of the present disclosure, the present disclosure is not limited to the exact construction and operation shown and described. Rather, those skilled in the art will readily appreciate that many changes and modifications to the present disclosure may be made without departing from the concept and scope of the appended claims.

### DESCRIPTION OF SYMBOLS

10: Metal plate 20: Sealant film

100: Chamber 110: Opening

200: Transfer unit 210: Gripping part

211: Gripping block 212: Sealing member

220: Transfer part 300: Vacuum unit

400: Pressurizing unit 410: Heating block

412: Heater 420: Pressurizing movement part

430: Buffer member

What is claimed is:

1. A method for manufacturing a lead tab for a secondary battery, the method comprising:
(a) temporarily joining a sealant film to upper and lower surfaces of a metal plate;
(b) transferring the metal plate to which the sealant film is temporarily joined into a chamber;
(c) providing a vacuum pressure inside the chamber; and
(d) pressurizing and adhering the sealant film to a surface of the metal plate inside the chamber.

2. The method of claim 1, wherein the step (c) is implemented to remove bubbles present between the metal plate and the sealant film.

3. The method of claim 1, wherein the step (d) is carried out while maintaining a set vacuum pressure formed inside the chamber through the step (c).

4. The method of any one of claim 1, wherein the step (d) is carried out while heating the sealant film to a first temperature above a predetermined level.

5. The method of claim 4, wherein the step (d) is carried out while heating the metal plate around the sealant film to a second temperature above a predetermined level,
wherein in the step (d), the heating of the sealant film and the heating of the metal plate are performed simultaneously, and
wherein the sealant film is adhered to the metal plate while melting a contact portion with the metal plate.

6. The method of claim 5, wherein the first temperature and the second temperature are the same.

7. The method of claim 5, wherein the step (d) is carried out while a heating block that generates high temperature heat for heating the sealant film and the metal plate does not come into direct contact with the sealant film and the metal plate, but comes into indirect contact with them through a buffer member having a higher ductility than the sealant film and the metal plate.

8. A device for manufacturing a lead tab for a secondary battery, which adheres a sealant film to a metal plate, the device comprising:
a chamber having an internal space above a predetermined size and an opening formed on one side;
a transfer unit that can grip the metal plate to which the sealant film is temporarily joined and then transfer it into the chamber or transfer it from an inside of the chamber to the outside;
a vacuum unit that provides a vacuum pressure inside the chamber;
a pressurizing unit configured to allow at least a portion of the sealant film to be accessible to the metal plate so as to pressurize the sealant film against a surface of the metal plate or to be movable to be spaced apart in an opposite direction; and
a control unit that controls the operations of the transfer unit, the vacuum unit, and the pressurizing unit.

9. The device of claim 8, wherein the transfer unit comprises:
a gripping part that can grip or ungrip the metal plate to which the sealant film is temporarily joined; and
a transfer part that moves the gripping part toward the chamber or conversely, transfers it away therefrom, and
wherein the gripping portion is configured to open or close the opening of the chamber and also has a structure that can seal an internal space of the chamber to the outside.

10. The device of claim 8, wherein the control unit drives the vacuum unit to maintain an inside of the chamber at a set vacuum pressure, and drives the pressurizing unit to pressurize and adhere the sealant film to a surface of the metal plate.

11. The device of claim 8, wherein the pressurizing unit can pressurize the sealant film and the metal plate around the sealant film while heating them to a temperature above a predetermined level.

12. The device of claim 8, wherein a portion of the pressurizing unit that comes into contact with the sealant film is configured to have a cross-sectional area larger than that of the sealant film.

13. The device of claim 11, wherein the pressurizing unit is provided on each of the upper and lower sides of the metal plate, each of which comprises:
a heating block configured to generate a high temperature above a predetermined temperature; and
a pressurizing movement part that can move the heating block toward or conversely, away from the metal plate and the sealant film, and when moving toward, the heating block pressurizes the sealant film so as to be closely adhered to the metal plate.

14. The device of claim 13, wherein the pressurizing unit further comprises:
a buffer member provided on one side of the heating block to have an elastic restoring force so as to allow the heating block to be configured to come into direct contact with the metal plate and the sealant film while preventing the heating block from coming into direct contact with the metal plate and the sealant film.
